(19) United States
(12) Patent Application Publication
(10) Pub. No.: US 2005/0263305 A1
(43) Pub. Date: Dec. 1, 2005

(54) Rotary impact tool

(75) Inventors: Hidenori Shimizu, Hikone-shi (JP); Toshiharu Ohashi, Sakata-gun (JP); Kozo Kawai, Neyagawa-shi (JP); Yoshinori Sainomoto, Sanda-shi (JP); Fumiaki Sawano, Hikone-shi (JP); Hiroshi Miyazaki, Hikone-shi (JP); Tadashi Arimura, Kyoto-shi (JP); Tatsuhiko Matsumoto, Habikino-shi (JP)

Correspondence Address: GREENBLUM & BERNSTEIN, P.L.C., 1950 ROLAND CLARKE PLACE, RESTON, VA, 20191, US

(73) Assignee: Matsushita Electric Works, Ltd., Osaka (JP)

(21) Appl. No.: 11/126,351

(22) Filed: May 11, 2005

(30) Foreign Application Priority Data
May 12, 2004 (JP) 2004-142844

(51) Int. Cl. B25D 1/00

(52) U.S. Cl. 173/2; 173/176

(57) ABSTRACT

A rotary impact tool can be used continuously for fastening a plurality of fastening members such as screws, bolts or nuts in tight fastening mode. The rotary impact tool comprises a rotary driving mechanism including a motor for rotating a driving shaft, a hammer engaged with the driving shaft, an output shaft to which a driving force is applied by impact blow of the hammer, a main switch operated by a user for controlling fastening operation, and a controller for controlling on and off of the motor. The controller has a normal fastening mode and a tight fastening mode, and a tight fastening mode setting switch used for setting the tight fastening mode is further comprised. When the tight fastening mode setting switch is switched on, the controller continuously drives the rotary driving mechanism so as to perform tight fastening operation continuously.

### BACKGROUND OF THE INVENTION

1. Field of the Invention

The present invention relates to a rotary impact tool such as an impact wrench or an impact driver used for fastening or loosening of fastening member such as a screw, a bolt or a nut.

2. Description of the Related Art

A rotary impact tool which can stop the driving of the motor automatically when a fastening torque reaches to a predetermined value is conventionally provided. In the actual fastening work, there, however, are many cases that the fastening torque of the fastening member is insufficient for preventing the over fastening. For preventing occurrence of the insufficient fastening torque, Japanese Laid-Open Patent Publication No. 2001-129767 shows a rotary impact tool which can fasten the fastening member a little more further to stop the fastening of the fastening member in normal fastening torque (it is called tight fastening mode).

In such a conventional rotary impact tool, when the user holds a main switch on after stopping to motor when a controller judges that the fastening torque reaches to a predetermined torque, the controller restarts the driving of the motor so as to apply a predetermined number of impact blows of a hammer, so that the tight fastening can be performed.

In such a conventional rotary impact tool with the tight fastening mode, the tight fastening mode cannot be transitive when the switching on state of the main switch after stopping the driving of the motor is maintained. Thus, if the user judges that the fastening of the fastening member is completed due to stop of the driving of the motor, the tight fastening bode cannot be transitive.

Furthermore, in the viewpoint of actual fastening operation, when there are a lot of members to be fastened, it is desirable that all the fastening members are fastened in normal fastening mode, and the tight fastening is continuously performed to the fastening members. The conventional rotary impact tool with the tight fastening mode, however, cannot be performed the tight fastening operation independently from the normal fastening operation, continuously.

### SUMMARY OF THE INVENTION

A purpose of the present invention is to provide a rotary impact tool, which can perform the tight fastening operation independently from the normal fastening operation, continuously.

A rotary impact tool in accordance with an aspect of the present invention comprises: a rotary driving mechanism including a motor for rotating a driving shaft; a hammer engaged with the driving shaft; an output shaft to which a driving force is applied by impact blow of the hammer; a main switch operated by a user for controlling fastening operation; a torque setting switch used by a user for setting a fastening torque; a torque calculator for calculating a fastening torque; and a controller for controlling on and off of the motor based on switching on and off of the main switch, an output of the torque calculator and the fastening torque set in the torque setting switch, and having a normal fastening mode and a tight fastening mode.

The rotary impact tool further comprises a tight fastening mode setting switch used for setting the tight fastening mode. When the tight fastening mode setting switch is switched on, the controller continuously drives the rotary driving mechanism so as to perform tight fastening operation continuously.

By such a configuration, when a user wishes to fasten a plurality of fastening members such as screws, bolts or nuts in tight fastening mode, the rotary impact tool can perform the tight fastening operations continuously when the tight fastening mode setting switch is switched on. Therefore, it is possible that all the fastening members are fastened in normal fastening mode, and the tight fastening is continuously performed to the fastening members.

### BRIEF DESCRIPTION OF THE DRAWINGS

FIG. 1 is a block diagram showing a configuration of a rotary impact tool in accordance with a first embodiment of the present invention;

FIG. 2 is a schematic sectional side view showing the configuration of the rotary impact tool in the first embodiment,

FIG. 3 is a sectional side view showing an example of a configuration of a driving mechanism of the rotary impact tool in the first embodiment;

FIG. 4 is a front view showing an example of a torque setting switch and a tight fastening mode setting switch of the rotary impact tool in the first embodiment;

FIG. 5 is a front view showing another example of a torque setting unit and a tight fastening mode setting switch of the rotary impact tool in the first embodiment;

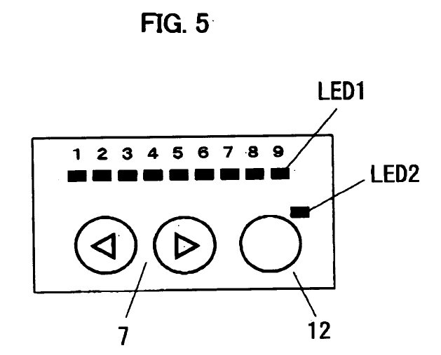

FIG. 6 is a time chart showing an example of an operation of the rotary impact tool in the first embodiment;

FIG. 7 is a block diagram showing a configuration of a rotary impact tool in accordance with a second embodiment of the present invention; and

FIG. 8 is a time chart showing an example of an operation of the rotary impact tool in the second embodiment.

### DETAILED DESCRIPTION OF THE EMBODIMENT

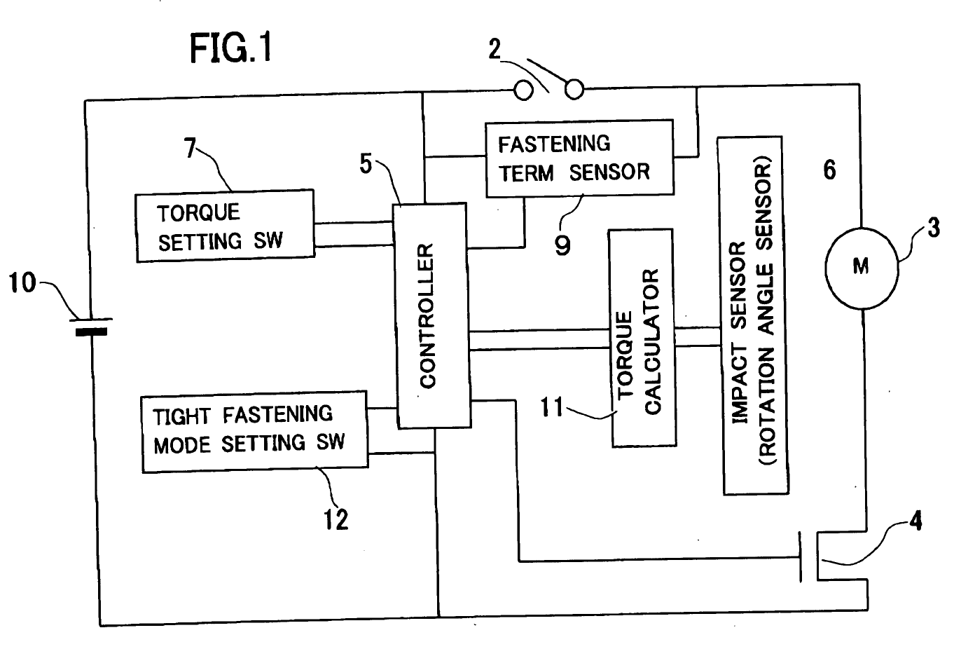

A rotary impact tool in accordance with a first embodiment of the present invention is described. A block configuration of the rotary impact tool is shown in FIG. 1. The rotary impact tool comprises a main switch 2 used for controlling the fastening operation, a motor 3, a switching device 4 used for on and off of driving the motor 3, a controller (control circuit) 5, an impact sensor 6 which further serves as a rotation angle sensor, a torque setting switch 7 used fir setting a fastening torque, a fastening term sensor (sensing circuit) 9, a battery 10 as a power source, a torque calculator (calculating circuit) 11 and a tight fastening mode setting switch 12. The battery 10, the main switch 2, the motor 3 and the switching device 4 are connected in series, and the series circuit is connected in parallel with the controller 5.

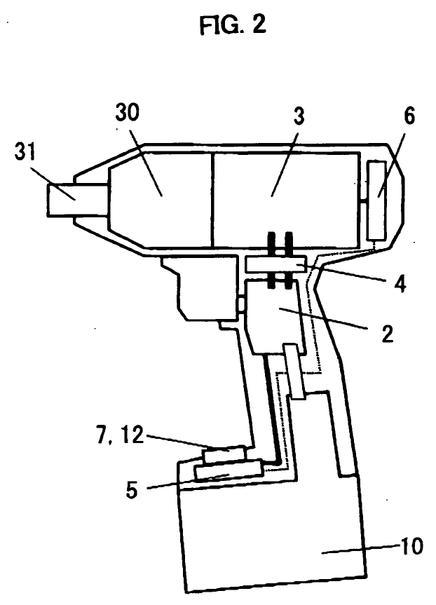

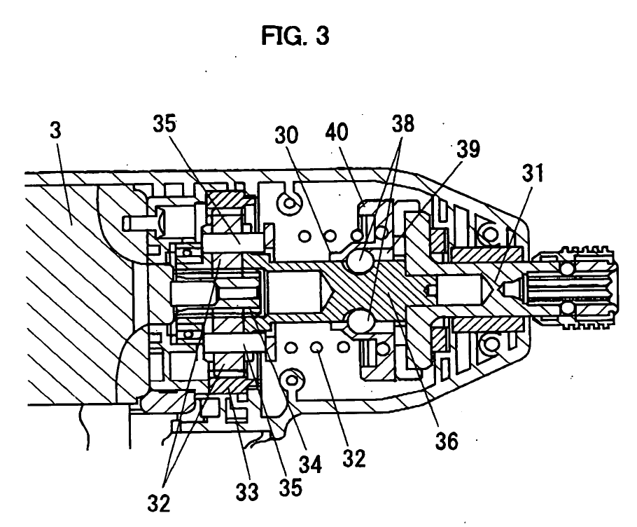

FIG. 2 shows schematic configuration of the rotary impact tool, and FIG. 3 shown specific example of a driving mechanism 30 for performing fastening operation of a fastening member such as a screw, a bolt or a nut by impact blow. As shown in FIG. 3, a reducer is configured by a sun gear 34, a pair of planet gears 32, and an internal gear 33. Rotation shafts 35 of the planet gears 32 are borne on a driving shaft 36. Rotation force of the motor 3 is transmitted to the driving shaft 36 via the reducer. A hammer 40 is engaged with an outer face of the driving shaft 36 via ball bearings 38 and a cam 39. A spring 37 is further provided between the driving shaft 36 and the hammer 40 for pressing the hammer 40 forward. The hammer 40 further has at least one engaging portion engaging with an anvil provided on an output shaft 31.

When no load is applied to the output shaft 31, the hammer 40 and the output shaft 31 are integrally rotated by the driving force of the motor 3. When a load equal to or larger than a predetermined value is applied to the output shaft 31, the hammer moves backward against the pressing force of the spring 37. When the engagement of the hammer 40 with the anvil of the output shaft 31 is released, the hammer 40 moves forward with rotation and applies impact blow in the rotation direction to the anvil of the output shaft 31, so that the output shaft 31 can be rotated.

In this embodiment, the impact senor 6 senses not only the occurrence of the impact blow of the hammer 40 with the anvil of the output shaft 31, but also a rotation angle of the anvil or the output shaft 31 in each impact blow of the hammer 40. As for the impact sensor 6, it is possible to include a rotary encoder provided on the motor 3 for sensing the rotation of the shaft of the motor 3. As the rotary encoder, a frequency generator, a magnetic rotary encode or an optical rotary encoder can be used. The frequency generator has a magnetized disc fixed on the shaft of the motor, and senses the rotation of the disc with a coil. The magnetic rotary encoder has a magnetized disc fixed on the shaft of the motor, and senses the rotation of the disc with a hall IC. The optical rotary encoder has a disc with slits fixed on the shaft of the motor, and senses the rotation of the disc with a photo-coupler. Output signal from the rotation encoder is processed the waveform shaping of pulse width signal corresponding to the rotation speed of the motor 3 through a waveform shaping circuit (not shown), and transmitted to the impact sensor 6.

Since the rotation speed of the motor 3 falls slightly due to a load change at the time of occurrence of the impact blow, the impact sensor 6 senses the occurrence of the impact blow of the hammer 40 utilizing a phenomenon that the pulse width of output of the rotation encoder becomes slightly longer.

The impact sensor 6, however, is not limited to this configuration. It is possible to sense the occurrence of the impact blow with using blow sound gathered with a microphone or with using an acceleration sensor.

In case that the torque calculator 11 calculates the fastening torque T₁ based on a number N of impact blows of the hammer 40, it is possible to estimate the fastening torque T₁ as the following formula.
T₁≅\sqrt{N}

In case that the torque calculator 11 calculates the fastening torque T₁ based a rotation angle θ of the output shaft 31 in each impact blow of the hammer 40, it is possible to calculate the fastening torque T₂ as the following formulae.
T₂∝(ω²/θ)
θ=(Δn/η)−(½)

Hereupon, rotation quantity (or angle) of the shaft of the motor 3 at each impact blow is designated by a symbol of Δn, a reduction ratio from the shaft of the motor 3 to the output shaft 31 is designated by a symbol η, and a rotation speed of the motor 3 is designated by ω.

The fastening term sensor 9 is connected in parallel with the main switch 2 so as to measure on time and off time of the main switch 2. The fastening term sensor 9, however, is not necessarily needed.

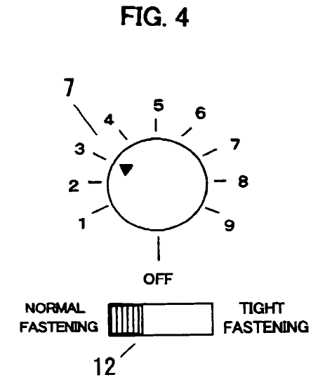

As for the torque setting switch 7, a type of a rotary switch shown in FIG. 4 or a type with a level meter LED1 of LED (light emitting diode) arrays and arrow keys used for increase or decrease the level of the indication of the level meter LED1 can be used.

As for the tight fastening mode setting switch 12, a type of a sliding switch shown in FIG. 4, or a type with a light emitting display LED2 such as an LED and a push switch can be used.

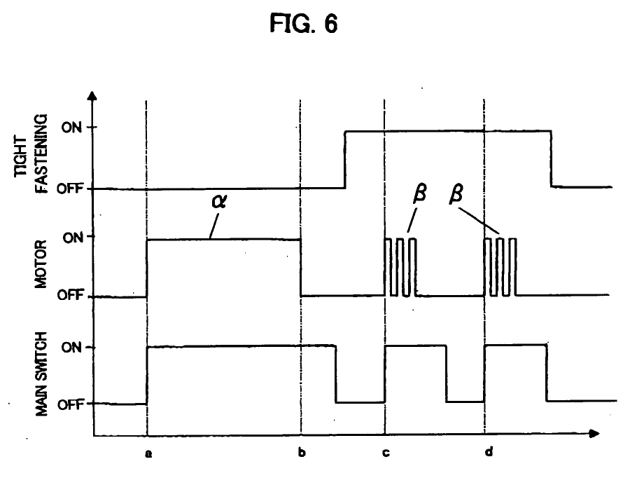

The rotary impact tool is essentially used in a normal fastening mode without tight fastening. In such a normal fastening mode, when the main switch 2 is switched on, the motor 3 starts to rotate, and the impact blows of the hammer 40 occurs, as shown in FIG. 6. When a fastening torque calculated in the torque calculator 11 reaches to a value of the torque set in the torque setting switch 7, the controller 5 switches off the switching device 4 so as to stop the driving of the motor 3, even in the switching on of the main switch 2. In FIG. 6, a term designated by a symbol a shows such a normal fastening operation.

When a user judges that it is further necessary for fastening the fastening member in tight fastening mode after switching off the main switch 2 due to stopping the motor 3, it is possible to make transition to the tight fastening mode by operating the tight fastening mode setting switch 12. After the transition to the tight fastening mode, when the user switched on the main switch 2 again, the controller 5 performs the tight fastening operation which is designated by a symbol β in FIG. 6, which is different from the normal fastening operation designated by the symbol α.

As for the tight fastening operation, for example, a predetermined number of impact blows of the hammer are performed. Alternatively, the impact blows of the hammer are performed in a predetermined term, until a number of rotations of the shaft of the motor 3 reaches to a predetermined reference number, or until the rotation angle of the output shaft 31 reaches to a predetermined angle. In case for performing the predetermined number of impact blows of the hammer 40, when the predetermined number of impact blows of the hammer 40 has been completed, the controller 5 stops driving of the motor 3 although the main switch 2 is switched on by the user. After that, when the main switch 2 is once switched off and switched on again, the controller 5 repeats the tight fastening operation until the tight fastening mode is off.

As for the above-mentioned predetermined number of the impact blows of the hammer 40, it is preferable to be set a value corresponding to the value of the fastening torque set in the torque setting switch 7. An example of relations between the values of phases of the torque setting switch 7 and the numbers of the impact blows of the hammer 40 is shown in the following table 1.

TABLE 1

| VALUE OF PHASES OF TORQUE | NUMBER OF IMPACT BLOWS |
|---|---|
| 1 | 2 |
| 2 | 4 |
| 3 | 6 |
| 4 | 8 |
| . | . |
| . | . |
| . | . |
| 9 | 30 |

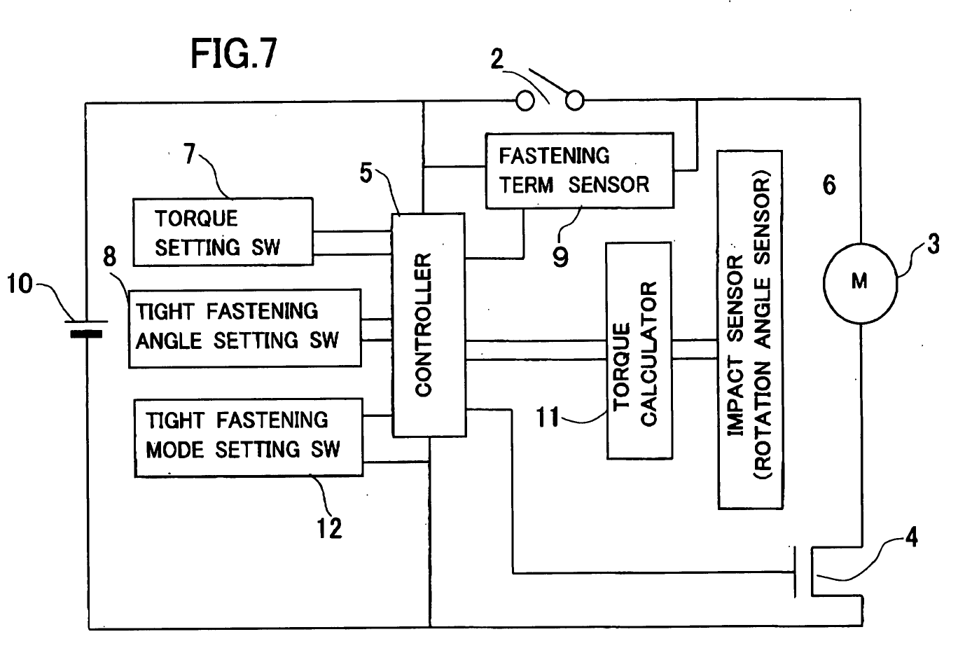

FIG. 7 shows a block configuration of another rotary impact tool in accordance with a second embodiment of the present invention. The rotary impact tool in the second embodiment further comprises a tight fastening angle setting switch 8. In the tight fastening mode, it is possible that the impact blows of the hammer 40 are performed by a tight fastening angle set in the tight fastening angle setting switch 8. Alternatively, it is possible to provide a switch fro setting a number or a term of impact blows of the hammer instead of the tight fastening angle setting switch 8.

It is further possible that the level of the phase of the torque set in the torque setting switch 7 is increased by one, when the tight fastening operations are repeated more than a predetermined times continuously. By such a configuration, the fastening torque in the next normal fastening mode or the quantity of the impact energy in the next tight fastening operation can be increased, automatically. Specifically, when the tight fastening operation in which the estimated fastening torque corresponds to the level of the phase 2 is performed, the level of the phase set in the torque setting switch 7 is automatically increased by one.

TABLE 2

| VALUE OF | |
|---|---|
| PHASES OF TORQUE | VALUE OF ESTIMATED TORQUE |
| 1 | 5 |
| 2 | 7 |
| 3 | 10 |
| 4 | 15 |
| . | . |
| . | . |
| . | . |
| 9 | 45 |

By the way, if the tight fastening operation cannot be performed without the switching operation in the tight mode setting switch 12, it is necessary for switching the tight mode setting switch 12, even when the user wishes to perform the tight fastening operation in succession to the normal fastening operation. It causes the decrease of the operationality of the rotary impact tool.

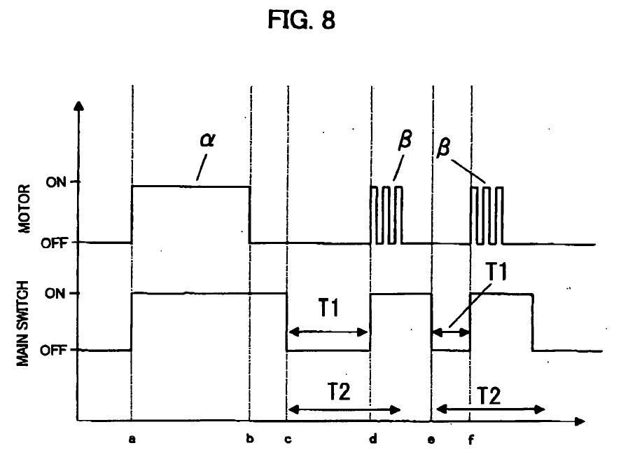

Then, the rotary impact tool in the first and second embodiments comprises the fastening term sensor 9. As shown in FIG. 8, when a term T1 between a time when the main switch 2 is switched off and a time when the main switch 2 is switched on again by the user is longer than a predetermined term T2, after the driving of the motor 3 is off due to completion of the normal fastening operation designated by the symbol α, it is possible that the controller 5 can perform the tight fastening operation designated by the symbol β, although the tight fastening mode setting switch 12 is switched off.

This application is based on Japanese patent application 2004-142844 filed May 12, 2004 in Japan, the contents of which are hereby incorporated by references.

Although the present invention has been filly described by way of example with reference to the accompanying drawings, it is to be understood that various changes and modifications will be apparent to those skilled in the art. Therefore, unless otherwise such changes and modifications depart from the scope of the present invention, they should be construed as being included therein.

1. A rotary impact tool comprising:
a rotary driving mechanism including a motor for rotating a driving shaft;
a hammer engaged with the driving shaft;
an output shaft to which a driving force is applied by impact blow of the hammer;
a main switch operated by a user for controlling fastening operation;
a torque setting switch used by a user for setting a fastening torque;
a torque calculator for calculating a fastening torque; and
a controller for controlling on and off of the motor based on switching on and off of the main switch, an output of the torque calculator and the fastening torque set in the torque setting switch, and having a normal fastening mode and a tight fastening mode; wherein
a tight fastening mode setting switch used for setting the tight fastening mode is further comprised; and
when the tight fastening mode setting switch is switched on, the controller continuously drives the rotary driving mechanism so as to perform tight fastening operation continuously.

2. The rotary impact tool in accordance with claim 1 further comprising:
a rotation angle sensor for sensing rotation angle of the output shaft to which rotation force due to impact blow of the hammer is applied or a rotation angle of a shaft of the motor; wherein
the torque calculator calculates the fastening torque based on an output of the rotation angle sensor; and
the controller stops driving of the motor when the rotation angle obtained from an output of the rotation angle sensor becomes equal to or larger than a predetermined reference value in the tight fastening mode.

3. The rotary impact tool in accordance with claim 2 further comprising:
a tight fastening angle setting switch used for setting or varying the predetermined reference value set in the tight fastening mode.

4. The rotary impact tool in accordance with claim 1, wherein
the controller stops driving of the motor when a quantity of impact blows of the hammer corresponding to the fastening torque set in the torque setting switch.

5. The rotary impact tool in accordance with claim 1, wherein
the controller increases a level of phase of the fastening torque set in the torque setting switch by one, when a number of tight fastening operations reaches to a predetermined times.

6. The rotary impact tool in accordance with claim 2, wherein
the controller increases a level of phase of the fastening torque set in the torque setting switch by one, when a number of tight fastening operations reaches to a predetermined times.

7. The rotary impact tool in accordance with claim 3, wherein
the controller increases a level of phase of the fastening torque set in the torque setting switch by one, when a number of tight fastening operations reaches to a predetermined times.

8. The rotary impact tool in accordance with claim 4, wherein
the controller increases a level of phase of the fastening torque set in the torque setting switch by one, when a number of tight fastening operations reaches to a predetermined times.
